(19) United States
(12) Patent Application Publication
(10) Pub. No.: US 2014/0140403 A1
(43) Pub. Date: May 22, 2014

(54) Methods and Systems for Encoding and Decoding Wide Color-Gamut Video

(71) Applicant: Sharp Laboratories of America, Inc., Camas, WA (US)

(72) Inventors: Christopher A. Segall, Vancouver, WA (US); Jie Zhao, Vancouver, WA (US)

(73) Assignee: Sharp Laboratories of America, Inc., Camas, WA (US)

(21) Appl. No.: 14/170,304

(22) Filed: Jan. 31, 2014

Related U.S. Application Data
(63) Continuation of application No. 12/894,065, filed on Sep. 29, 2010.

(51) Int. Cl. H04N 19/186; H04N 19/51; H04N 19/44; H04N 19/50

(52) U.S. Cl. CPC H04N 19/00315; H04N 19/00569; H04N 19/00587; H04N 19/00533
USPC 375/240.12

(57) ABSTRACT

Aspects of the present invention relate to systems and methods for capturing, encoding and decoding wide color-gamut video. According to a first aspect of the present invention, a plurality of processed image frames are associated with a legacy bit-stream, and a plurality of unprocessed image frames are associated with an enhancement bit-stream.

### FIELD OF THE INVENTION

Embodiments of the present invention relate generally to video capture and coding and decoding of video sequences and, in particular, some embodiments of the present invention comprise methods and systems for capturing wide color-gamut video and for encoding and decoding the captured video.

### SUMMARY

Some embodiments of the present invention comprise methods and systems for capturing wide color-gamut video and for encoding and decoding the captured video.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture showing exemplary embodiments of the present invention comprising an image sensor module and a host processor, wherein the host processor may request unprocessed image frames from the imaging sensor module for which the imaging sensor module may disable internal image processing functionality;

FIG. 2 is a chart showing exemplary embodiments of the present invention comprising capturing processed and unprocessed image frames;

FIG. 3 is a chart showing exemplary embodiments of the present invention comprising enabling and disabling internal processing based on a received control signal from a host processor at an image sensor module;

FIG. 4 is picture illustrating an exemplary image sequence comprising processed image frames and unprocessed image frames;

FIG. 5 is a picture illustrating associating processed image frames with a legacy bit-stream;

FIG. 6 is a picture illustrating interpolating processed image frames at time instances in a legacy bit-stream associated with acquired unprocessed image frames;

FIG. 7 is a picture illustrating prediction of enhancement bit-stream unprocessed image frames from legacy bit-stream image frames;

FIG. 8 is a picture illustrating prediction of enhancement bit-stream unprocessed image frames from previous unprocessed image frames in the enhancement layer; and

FIG. 9 is a picture illustrating prediction of enhancement bit-stream unprocessed image frames from previous unprocessed image frames in the enhancement layer and camera-inverted legacy bit-stream processed image frames.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

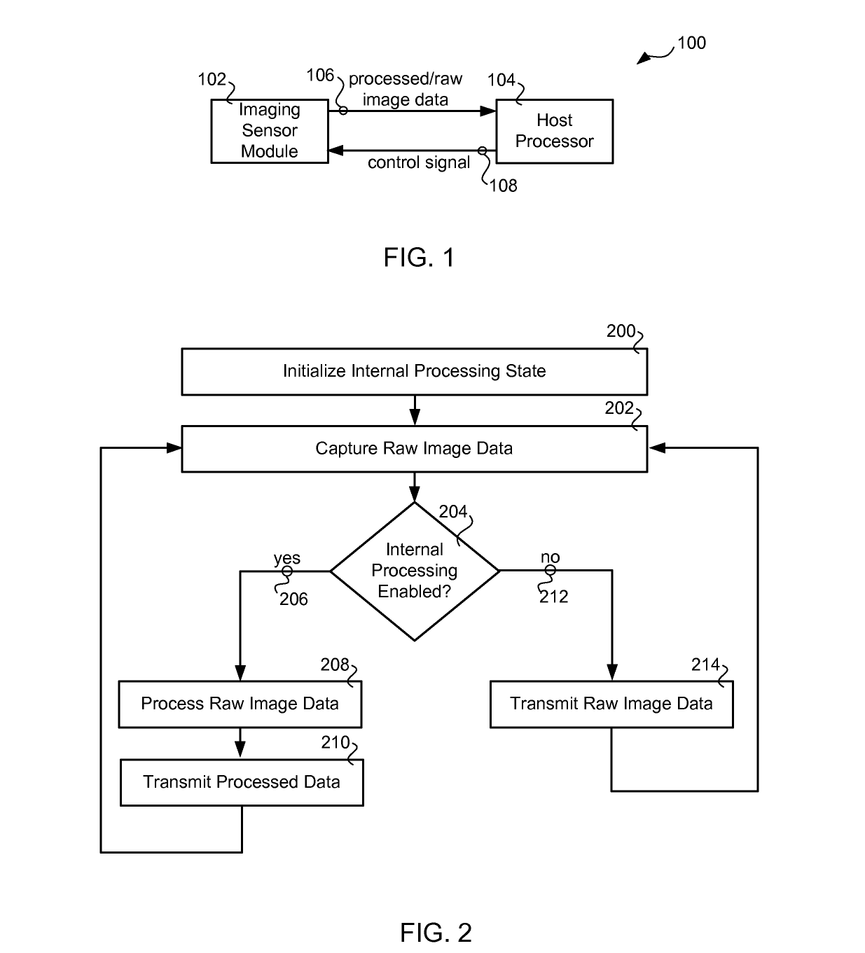

Some embodiments of the present invention described in relation to FIG. 1 comprise an acquisition system 100 for capturing wide color-gamut video. These embodiments comprise an imaging sensor module 102 and a host processor 104. The imaging sensor module 102 may capture raw image data and may process the raw image data thereby converting the raw image data to a display referred model. Exemplary processing may include white balancing, de-mosaicing, gamma correction, color-space conversion, for example, conversion to a standard color space, for example, BT-709 or other standard color space, and other processing necessary to convert the raw image data to a display referred model. The imaging sensor module 102 may transmit the processed image data or the raw, unprocessed image data 106 to the host processor 104. The host processor 104 may compress the received image data. The imaging sensor module 102 may transmit processed or raw image data 106 based on a control signal 108 sent to the imaging sensor module 102 from the host processor. The host processor may periodically send a control signal 108 to the imaging sensor module 102 requesting the imaging sensor module 102 provide unprocessed, also considered raw, image data 106. The imaging sensor module 102, upon receipt of a control signal 108 requesting raw image data, may disable internal processing, for example, white balancing, de-mosaicing, color-space conversion, gamma correction and other internal processing required to convert the raw image data to a display referred model. In some embodiments of the present invention, the imaging sensor module 102 may send unprocessed image data in response to a request from the host processor for a fixed number of frames before re-enabling internal processing. In alternative embodiments, the imaging sensor module 102 may send unprocessed image data in response to a request from the host processor until a subsequent request for processed data is received at the imaging sensor module 102 from the host processor 104. When the subsequent request for processed data is received, the imaging sensor module 102 may enable internal processing.

Some embodiments of the present invention may be understood in relation to FIG. 2. An imaging sensor module may initialize 200 an internal processing state to “enabled” or “disabled.” The imaging sensor module may capture 202 raw image data. The internal processing state may be examined 204. If internal processing is enabled 206, then the raw image data may be processed 208 to convert the raw image data to a display referred model, and the processed data may be transmitted 210 to a host processor. The next frame of raw image data may be captured 202. If internal processing is disabled 212, then the raw, unprocessed image data may be transmitted 214 to the host processor, and the next frame of raw image data may be captured 202.

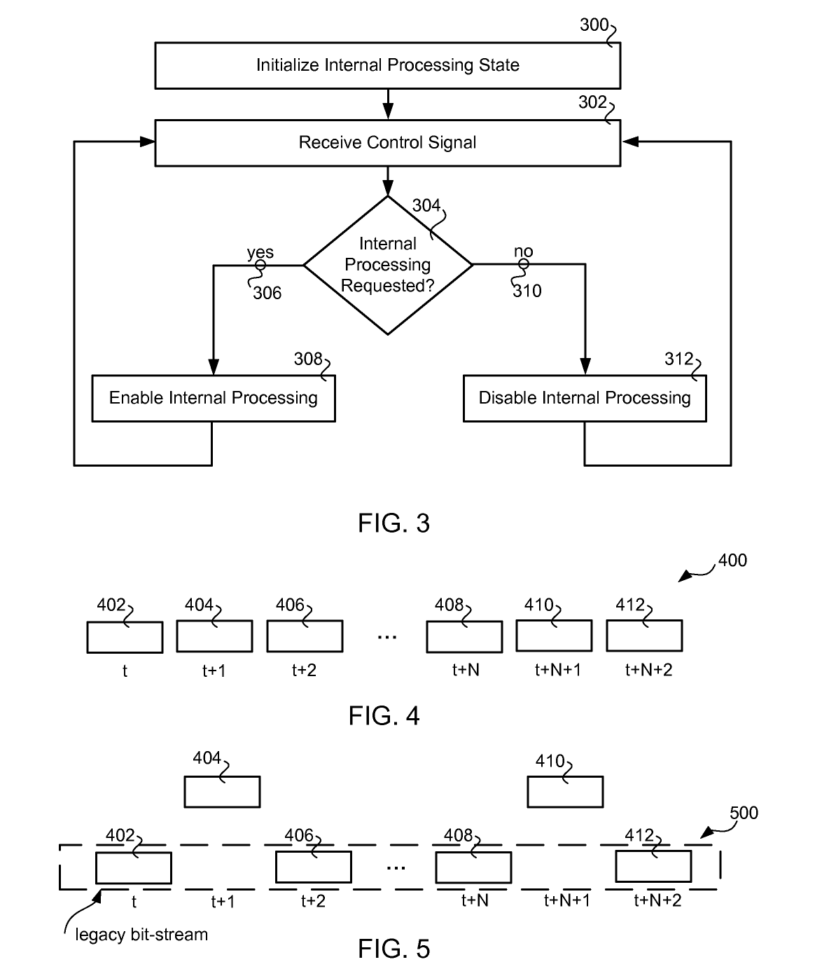

Some embodiments of the present invention may be further understood in relation to FIG. 3. An imaging sensor module may initialize 300 an internal processing state to “enabled” or “disabled.” The imaging sensor module may receive 302 a control signal, from a host processor, the control signal may be examined 304. If the control signal indicates that internal processing is requested 306, then the imaging sensor module may enable internal processing and wait to receive 302 a subsequent control signal. If the control signal indicates that raw data is requested 310, then the imaging sensor module may disable internal processing and wait to receive 302 a subsequent control signal.

Referring again to FIG. 1, in some embodiments of the present invention, the host processor 104 may compress the received image data 106 and may transmit the compressed data to another device or external storage. In alternative embodiments, the host processor 104 may store the compressed data internally.

In some embodiments of the present invention, the host processor 104 may store the unprocessed data as enhancement information in the video data. In alternative embodiments of the present invention, the host processor 104 may compress the enhancement information. In some embodiments, the host processor 104 may store, in the video data, additional enhancement describing the internal color space of the imaging sensor.

The acquisition system 100 for capturing wide color-gamut video may generate a sequence 400 of image frames as illustrated in FIG. 4. The frames 402, 406, 408, 412 represent frames captured with internal processing enabled, and the frames 404, 410 represent frames captured with internal processing disabled. Thus, the frames captured at t+1 and t+N+1 contain wider color gamut than those captured at t, t+2, t+N and t+N+2 . The sequence 400 of image frames may be compressed for storage and transmission. In some embodiments of the present invention, compression systems supported by a legacy devices may be used, for example, H.264/AVC, MPEG-2, MPEG-4 and other compression methods employed by legacy devices. The processed image frames 402, 406, 408, 412 may be referred to as the legacy bit-stream, 500 as depicted in FIG. 5, and these frames may be decoded and displayed on legacy devices. At time locations 404, 410 corresponding to the unprocessed image data, for example, t+1 and t+N+1, the legacy bit-stream does not contain image data. In many video coding systems, a decoder may optionally perform temporal interpolation to synthesize the missing frames.

In some embodiments of the present invention, in the encoding process, the host processor may insert, at bit-stream locations associated with these time instances, a bit-stream instruction to copy the image intensity values from a previous time instance to a current time instance. This bit-stream instruction may be referred to as a “skip frame.”

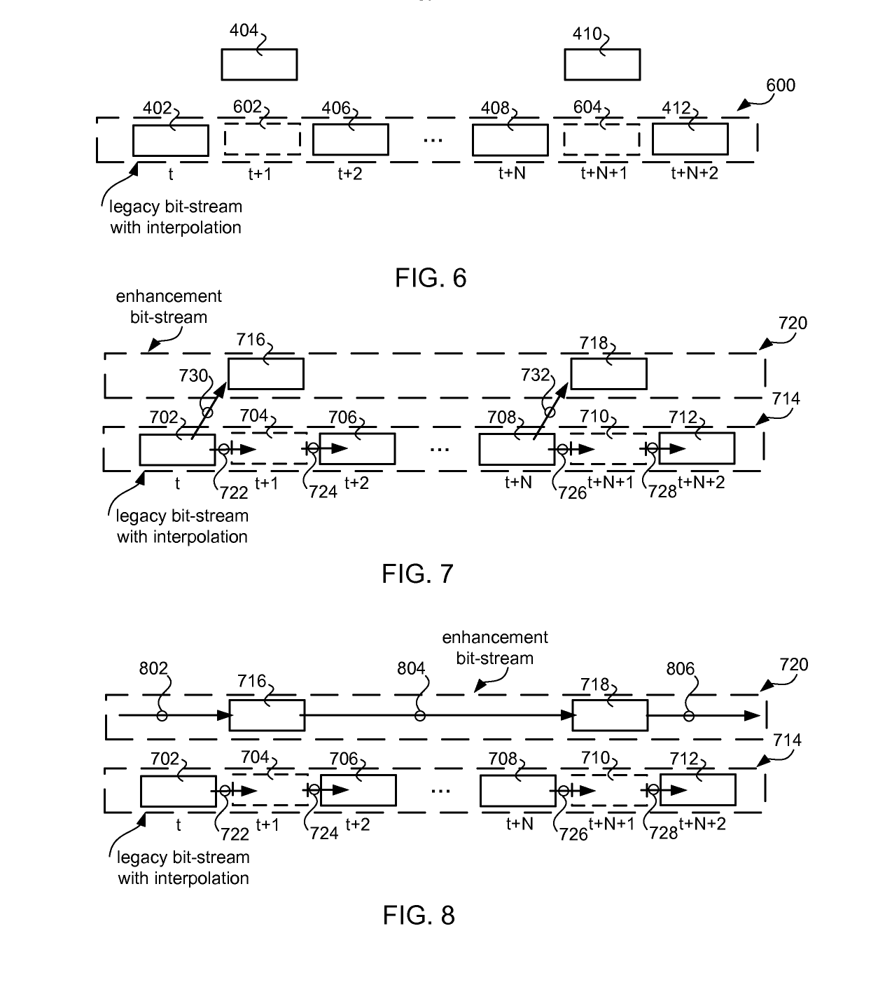

In alternative embodiments of the present invention, the host processor may simulate internal camera processing using the unprocessed frames to construct interpolated data at the unprocessed frames time instances. In some embodiments of the present invention, an interpolated frame may be coded explicitly. In alternative embodiments, an interpolated frame may be coded using bit-stream information, for example, motion vectors, coding modes and other bit-stream information from neighboring temporal frames. FIG. 6 depicts a legacy bit-stream 600 with interpolated frames 602, 604 at time instances corresponding to unprocessed image frames.

In some embodiments of the present invention, the wide color-gamut, unprocessed image frames, referred to as enhancement data, may be encoded so that it may be ignored by legacy decoders. In some embodiments of the present invention, this may be achieved by creating an enhancement bit-stream. In some embodiments, the enhancement and legacy bit-streams may be interleaved. Exemplary methods for interleaving the enhancement and legacy bit-streams may comprise using user-data markers, alternative NAL unit values and other methods known in the art. In alternative embodiments, the enhancement bit-stream and the legacy bit-stream may be multiplexed as separate bit-streams with a larger transport container. In yet alternative embodiments of the present invention, the legacy bit-stream and the enhancement bit-stream may be transmitted, or stored, separately.

In some embodiments of the present invention, the enhancement-layer data in the enhancement bit-stream may be encoded without prediction from other time instances or without prediction from the legacy bit-stream.

In alternative embodiments of the present invention, the enhancement-layer data may be encoded using image frames in the legacy bit-stream as reference frames. These embodiments may be understood in relation to FIG. 7 which depicts a plurality of image frames 702, 704, 706, 708, 710, 712 in a legacy bit-stream 714. Frames 702, 704, 706, 708, 710, 712 in the legacy bit-stream 714 are of two types: acquired, processed frames 702, 706, 708, 712 and interpolated frames 704, 710 at time instances corresponding to acquired, unprocessed frames 716, 718. The unprocessed frames 716, 718 form the enhancement layer 720. The frames 702, 704, 706, 708, 710, 712 in the legacy bit-stream 714 may be encoded using motion compensation and prediction between frames within the legacy bit-stream 714 as indicated by the arrows 722, 724, 726, 728 between the frames. For example, the interpolated frame 704 at time t+1 may be predicted using the frame 702 at time t as indicated by the arrow 722 between the frames 702, 704. The frame 706 at time t+2 may be predicted using the interpolated frame 704 at time t+1 as indicated by the arrow 724 between the frames 704, 706. The interpolated frame 710 at time t+N+1 may be predicted using the frame 708 at time t+N as indicated by the arrow 726 between the frames 708, 710. The frame 712 at time t+N+2 may be predicted using the interpolated frame 710 at time t+N+1 as indicated by the arrow 728 between the frames 710, 712. Additionally, the unprocessed frames 716, 718 in the enhancement layer 720 may be predicted using motion-compensated prediction from reference frames within the legacy bit-stream 714. For example, the unprocessed frame 716 at time t+1 in the enhancement layer 720 may be predicted from the legacy bit-stream frame 702 at time t as indicated by the arrow 730 between the frames 702, 716, and the unprocessed frame 718 at time t+N+1 in the enhancement layer 720 may be predicted from the legacy bit-stream frame 708 at time t+N as indicated by the arrow 732 between the frames 708, 718.

In yet alternative embodiments of the present invention, the enhancement-layer data may be encoded using image frames in the enhancement bit-stream as reference frames.

These embodiments may be understood in relation to FIG. 8 which depicts a plurality of image frames 702, 704, 706, 708, 710, 712 in a legacy bit-stream 714. Frames 702, 704, 706, 708, 710, 712 in the legacy bit-stream 714 are of two types: acquired processed frames 702, 706, 708, 712 and interpolated frames 704, 710 at time instances corresponding to acquired, unprocessed frames 716, 718. The unprocessed frames 716, 718 form the enhancement layer 720. The unprocessed frames 716, 718 in the enhancement layer 720 may be predicted using motion-compensated prediction from reference frames within the enhancement layer 720. For example, the unprocessed frame 716 at time t+1 in the enhancement layer 720 may be predicted from the immediately preceding enhancement bit-stream frame as indicated by the arrow 802, and the unprocessed frame 718 at time t+N+1 in the enhancement layer 720 may be predicted from the enhancement bit-stream frame 716 at time t+1 as indicated by the arrow 804 between the frames 716, 718. The enhancement bit-stream frame 718 may be used to predict an immediately subsequent enhancement bit-stream frame as indicated by the arrow 806.

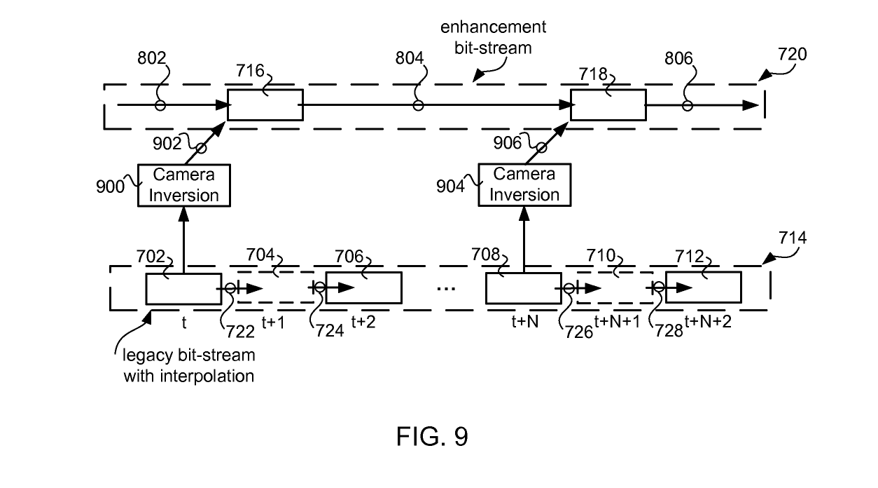

In some embodiments of the present invention, both inter-frame within a bit-stream and inter-bit-stream prediction may be used. In some of these embodiments, a mapping process may be used to project a frame captured under a first processing state to a second processing state. For example, a camera inversion process may be used on a processed image frame from the legacy bit-stream prior to using the frame for prediction of an unprocessed image frame in the enhancement bit-stream. The camera inversion process may reverse the on-board internal processing of the imaging sensor module. FIG. 9 depicts the prediction of the unprocessed frames 716, 718 in the enhancement layer 720 using motion-compensated prediction from reference frames within the enhancement layer 720 and projected frames from the legacy bit-stream 714. For example, the unprocessed frame 716 at time t+1 in the enhancement layer 720 may be predicted from the immediately preceding enhancement bit-stream frame as indicated by the arrow 802 and the legacy bit-stream frame at time t after camera inversion 900 as indicated by the arrow 902. The unprocessed frame 718 at time t+N+1 in the enhancement layer 720 may be predicted from the enhancement bit-stream frame 716 at time t+1 as indicated by the arrow 804 between the frames 716, 718 and the legacy bit-stream frame at time t+N after camera inversion 904 as indicated by the arrow 906.

In some embodiments of the present invention, a legacy decoder may decode the legacy bit-stream and output a video sequence to a display device. In some embodiments of the present invention, the enhancement bit-stream may be decoded in addition to the legacy bit-stream and may output a video sequence with a wider color-gamut than that of the legacy bit-stream. In some embodiments of the present invention, when a decoder decodes an enhancement bit-stream, the frames in the legacy bit-stream that correspond to the time instances of the frames within the enhancement bit-stream may not be decoded and reconstructed.

Although the charts and diagrams shown in the figures herein may show a specific order of execution, it is understood that the order of execution may differ from that which is depicted. For example, the order of execution of the blocks may be changed relative to the shown order. Also, as a further example, two or more blocks shown in succession in the figure may be executed concurrently, or with partial concurrence. It is understood by those with ordinary skill in the art that software, hardware and/or firmware may be created by one of ordinary skill in the art to carry out the various logical functions described herein.

Some embodiments of the present invention may comprise a computer program product comprising a computer-readable storage medium having instructions stored thereon/in which may be used to program a computing system to perform any of the features and methods described herein. Exemplary computer-readable storage media may include, but are not limited to, flash memory devices, disk storage media, for example, floppy disks, optical disks, magneto-optical disks, Digital Versatile Discs (DVDs), Compact Discs (CDs), micro-drives and other disk storage media, Read-Only Memory (ROMs), Programmable Read-Only Memory (PROMs), Erasable Programmable Read-Only Memory (EPROMS), Electrically Erasable Programmable Read-Only Memory (EEPROMs), Random-Access Memory (RAMS), Video Random-Access Memory (VRAMs), Dynamic Random-Access Memory (DRAMs) and any type of media or device suitable for storing instructions and/or data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for encoding an image sequence, said method comprising:
inputting processed image data, wherein the processed image data is in a standard color-space;
inputting unprocessed image data, wherein the unprocessed image data is not in the standard color-space; and
multiplexing a legacy bit-stream and an enhancement bit-stream, wherein:
the legacy bit-stream is coded from the processed image data;
the legacy bit-stream is not coded from the unprocessed image data;
the enhancement bit-stream is coded from the unprocessed image data; and
an enhancement-layer frame corresponding to a first time instance is predicted using a decoded legacy-layer frame corresponding to a second time instance, wherein the first time instance and the second time instance are not the same time instance.

2. A method as described in claim 1, wherein the unprocessed image data represents a wider color gamut than the processed image data.

3. A method as described in claim 2, wherein the processed image data is coded using the processed image data and the legacy bit-stream.

4. A method as described in claim 3, wherein the unprocessed image data is coded using the unprocessed image data and the enhancement bit-stream.

5. A method as described in claim 2, wherein the unprocessed image data is coded using the unprocessed image data and the enhancement bit-stream.

6. A method as described in claim 1, wherein the processed image data is coded using the processed image data and the legacy bit-stream.

7. A method as described in claim 1, wherein the unprocessed image data is coded using the unprocessed image data and the enhancement bit-stream.

8. A method as described in claim 1, wherein the prediction of the enhancement-layer frame corresponding to the first time instance comprises converting the decoded legacy-layer frame corresponding to the second time instance to a color-space associated with the enhancement layer and performing motion-compensated prediction using the converted decoded legacy-layer frame.

9. A method as described in claim 1 further comprising encoding in the legacy bit-stream a skip-frame instruction associated with the first time instance.

10. A method as described in claim 1 further comprising encoding in the legacy bit-stream a first interpolated frame associated with the first time instance.

11. A method as described in claim 1 further comprising interleaving the legacy bit-stream and the enhancement bit-stream using a method selected from the group consisting of a user-data marker method and an alternative NAL unit values method.

12. A method as described in claim 1 further comprising multiplexing separately the legacy bit-stream and the enhancement bit-stream in a transport container.

13. A method as described in claim 1 further comprising:
transmitting the legacy bit-stream; and
separately transmitting the enhancement bit-stream.

14. A method for decoding a video sequence, said method comprising:
receiving a legacy bit-stream in which a processed image data is coded;
receiving an enhancement bit-stream in which an unprocessed image data is coded; and
predicting an enhancement-layer frame corresponding to a first time instance using a decoded legacy-layer frame corresponding to a second time instance, wherein the first time instance and the second time instance are not the same time instance.

15. A method as described in claim 14, wherein the unprocessed image data represents a wider color gamut than the processed image data.

16. A method as described in claim 15, wherein a reconstructed processed image data is decoded using the legacy bit-stream.

17. A method as described in claim 16, wherein a reconstructed unprocessed image data is decoded using the legacy bit-stream and the enhancement bit-stream.

18. A method as described in claim 14, wherein the predicting comprises converting the decoded legacy-layer frame corresponding to the second time instance to a color-space associated with the enhancement layer.

19. A method as described in claim 18, wherein the predicting further comprises motion-compensated prediction using the converted decoded legacy-layer frame.

20. A method as described in claim 14, wherein the predicting comprises prediction from the legacy-layer frame and a previously decoded unprocessed image frame.
